(19) United States
(12) Patent Application Publication
(10) Pub. No.: US 2016/0019231 A1
(43) Pub. Date: Jan. 21, 2016

(54) REPORTING TOOL AND METHOD THEREFOR

(71) Applicant: BYCITE SOFTWARE LTD., Hod Hasharon (IL)

(72) Inventor: Israel TWITO, Hod Hasharon (IL)

(73) Assignee: BYCITE SOFTWARE LTD., Hod Hasharon (IL)

(21) Appl. No.: 14/774,230

(22) PCT Filed: Feb. 5, 2014
(86) PCT No.: PCT/IB2014/058804

§ 371 Date: Sep. 10, 2015

Related U.S. Application Data
(60) Provisional application No. 61/782,532, filed on Mar. 14, 2013.

(51) Int. Cl. G06F 17/30

(52) U.S. Cl. CPC G06F 17/30112; G06F 17/30011; G06F 17/30106

(57) ABSTRACT

A reporting tool is used to execute a method of designating publications to cite in a report. The reporting tool opens a report in response to a request received from a client computer. The reporting tool receives from the client computer an indication of publications. Then, the reporting tool uses storage to find information in storage that links the publications to other publications found in the storage. At that point, the reporting tool sends a suggestion to the client computer to cite the newly-found publications in the report. The reporting tool has multiple uses, such as facilitating the process of generating a prior art search report.

### BACKGROUND

Many enterprises begin with substantial investments directed toward developing inventions that will reap significant profits in the future. Frequently, competitors who have not invested comparable resources may copy the inventions with relatively little effort. Accordingly, the inventing enterprises often seek protection in the form of patents, which allow the enterprises to enforce a temporary monopoly relating to the inventions.

An applicant for a patent does not receive the patent until the patent application passes the thorough examination process of a jurisdiction's patent office, for example, the United States Patent and Trademark Office. An application may be rejected for any of a variety of reasons, for example, the invention as described in the claims is not “novel” (that is, the claimed invention already exists) or it is novel but it is “obvious” (for example, no special ingenuity caused the invention or there is no unexpected advantage associated with the invention). To reject a claim as lacking novelty or as obvious, the patent examiner must justify the rejection in a communication called an “office action.” The office action must cite the “prior art,” that is, the publication of the technology upon which the lack of novelty or non-obviousness rejection is based. Prior art may be issued patents of any country, published applications of any jurisdiction, non-patent publications (for example, a technical journal), public demonstrations, internet web pages, et cetera.

Although an applicant often has the opportunity to amend the claims to overcome the rejection, for example, to describe a feature of the invention that is not disclosed or even suggested in the prior art, the resulting patent is potentially stronger legally if the claims were originally in condition for allowance when the application was filed. Even though most patent applications are rejected at least once during examination, the resulting patent can be expected to fare better after the patent grant if the claim amendments during examination were more of a minimal nature.

Accordingly, patent attorneys regularly advise their clients to conduct prior art searches to enable the patent attorneys to draft better claims. Additionally, a prior art search may find documentation so close to a client's invention that very little claim scope would likely result from a subsequently issued patent. As unwelcome as such news is received by the client, it is preferable to be informed of the state of the art before substantial investment is made attempting to patent an invention and promoting the invention for the market. In another scenario, a “portion” of an invention is found in a prior art search, so the client and attorney work together to focus efforts on the part of the invention that has not been found. Such effort is also better invested early and before filing the patent application.

A proper prior art search is difficult to perform for someone without the proper skills and tools. A skilled searcher can find highly relevant prior art that an inexperienced searcher may never notice. As a result of the importance of a proper prior art search, specialized services have developed over the years which employ skilled searchers and equip them with the proper tools, such as access to both public and private prior art databases. Numerous algorithms are available to assist the searcher, and improved algorithms are continually being developed.

After the searcher determines which prior art to provide to the applicant, the searcher must present it in a fashion that easily directs the applicant's attention to the appropriate areas. For example, the most relevant part of a twenty page publication may be five lines of text on the sixteenth page. Various applications for efficiently generating search reports are also continually being developed.

Prior art searches are useful in other situations besides helping one decide whether to file a patent application and, if so, how to prepare it. For example, a party accused of patent infringement or assessing the risk of such accusation wants to know of prior art that may be applied to invalidate claims of the patent. In some limited situations, for an application for patent that is still pending, a party adverse to the grant of the patent may submit material prior art to a jurisdiction's patent office in the hopes that the patent office will reject the claims based on the submission.

It thus would be highly beneficial to equip a prior art searcher with efficient tools that enable him/her to quickly find the prior art that is most relevant (material) to a specific need.

### SUMMARY

The present inventor has developed an invention that includes various mechanisms to aid the prior art searcher in providing to a client the material prior art. The invention also aids the searcher in quickly and efficiently providing to the client a search report that directs the client's attention quickly and easily to the most relevant information in the prior art cited in the report.

The invention may be embodied as a method of designating publications to cite in a report. The method includes: opening a report in response to a request received from a client computer; receiving from the client computer an indication of a first set of one or more publications; using storage to find information that links the publications of the first set to one or more publications of a second set of publications; and sending a suggestion to the client computer to cite the publications of the second set in the report.

The invention may also be embodied as a reporting tool. The reporting tool has an input interface, a processor, a first storage, and an output interface. The input interface is operative to receive from a client computer (1) a request to open a report and (2) an indication of a first set of one or more publications. The processor is operative to open the report in response to the request. The first storage is operatively connected to the processor and holds instructions that when executed activate the processor to use a second storage to find information that links at least one publication in the first set to one or more publications of a second set of one or more publications. The output interface is operative to send to the client computer a suggestion to cite the publications of the second set in the report.

The invention may further be embodied as a machine readable medium holding instructions that when executed activate a processor to execute a method of designating publications to cite in a report. The method executed includes: opening a report in response to a request received from a client computer; receiving from the client computer an indication of a first set of one or more publications; using storage to find information that links the publications of the first set to one or more publications of a second set of publications; and sending a suggestion to the client computer to cite the publications of the second set in the report.

Embodiments of the present invention are described in detail below with reference to the accompanying drawings, which are briefly described as follows:

### BRIEF DESCRIPTION OF THE DRAWINGS

The invention is described below in the appended claims, which are read in view of the accompanying description including the following drawings, wherein:

FIG. 1 illustrates a prior art search report;

FIG. 2 illustrates a search report provided by a governmental patent office;

FIG. 3 illustrates diagrammatically the invention embodied as a reporting tool and the system in which the embodiment operates;

FIG. 3a illustrates diagrammatically in more detail the input/output interface assembly of the reporting tool of FIG. 3 and some of the components operating with the input/output interface assembly;

FIG. 4 presents a flowchart that illustrates the process flow of a method of designating publications to cite in a report according to an embodiment of the invention, which may be performed by the reporting tool of FIG. 3;

FIG. 5 illustrates the interaction of an embodiment of the reporting tool with a user and storage while implementing a report co-citation process;

FIG. 6 illustrates the interaction of an embodiment of the reporting tool with a user and storage while implementing a publication co-citation process;

FIG. 7 illustrates the interaction of an embodiment of the reporting tool with a user and storage while implementing a report bibliographic coupling process;

FIG. 8 illustrates the interaction of an embodiment of the reporting tool with a user and storage while implementing a publication bibliographic coupling process;

FIG. 9 illustrates the interaction of an embodiment of the reporting tool with a user and storage while implementing a publication metadata coupling process;

FIG. 10 illustrates the interaction of an embodiment of the reporting tool with a user and storage while implementing a report metadata coupling process;

FIG. 11 illustrates the interaction of an embodiment of the reporting tool with a user and storage while implementing a publication class coupling process;

FIG. 12 illustrates the interaction of an embodiment of the reporting tool with a user and storage while implementing a report class coupling process; and

FIG. 13 illustrates the interaction of an embodiment of the reporting tool with a user and storage while implementing a content coupling process.

### DETAILED DESCRIPTION

The invention summarized above and defined by the claims below will be better understood by referring to the present detailed description of embodiments of the invention. This description is not intended to limit the scope of claims but instead to provide examples of the invention.

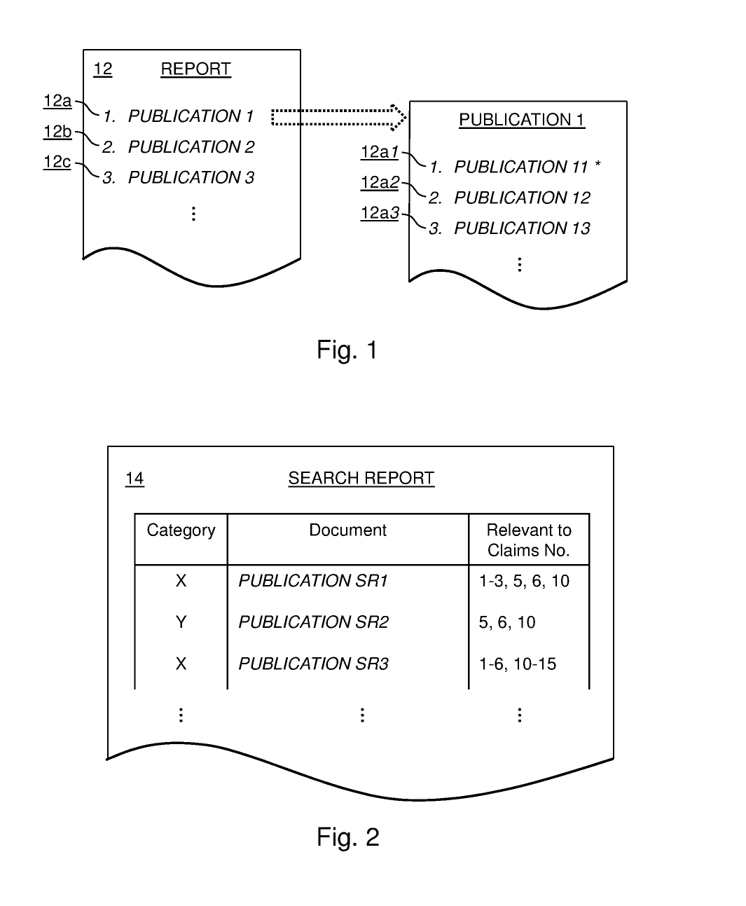

Embodiments of the present invention produce prior art search reports, such as the report 12 in FIG. 1. As illustrated, the report 12 lists multiple publications 12a, 12b, 12c, . . . . The publication 12a is an issued patent, the publication 12b is a published patent application, and the publication 12c technical journal article. These are non-limiting examples of publications suitable for prior art search reports. Another example publication is a newspaper article for the lay public, and the list of examples continues. Prior art search reports that embodiments of the present invention produce are useful, as an example, for determining the aspects of an innovation upon which to focus when preparing a patent application (patentability studies) and for determining and/or challenging the validity issued patent claims.

Often publications themselves list publications that are relevant to the creating of the listing publications. For example, an issued U.S. patent usually lists publications that either the applicant or the examiner considered material to examination before the patent issued. As another example, a technical journal article will often include a bibliography of older publications that support assertions in the article. As illustrated in FIG. 1, the patent 12a lists publications 12a1, 12a2, 12a3 . . . . The first publication was cited by the examiner, as indicated by the asterisk (“*”), and the remaining publications were cited by the applicant during prosecution.

Some patent applications, such as those published by the World Intellectual Property Organization (WIPO), the European Patent Office (EPO), and the Intellectual Property Office of the United Kingdom, typically include search reports, such as the example search report 14 illustrated in FIG. 2. For each listed document, the search report indicates the claims to which the document is relevant and the document's “category.” A category may indicate for example that the cited document prevents the corresponding claim meeting novelty or inventive step requirements.

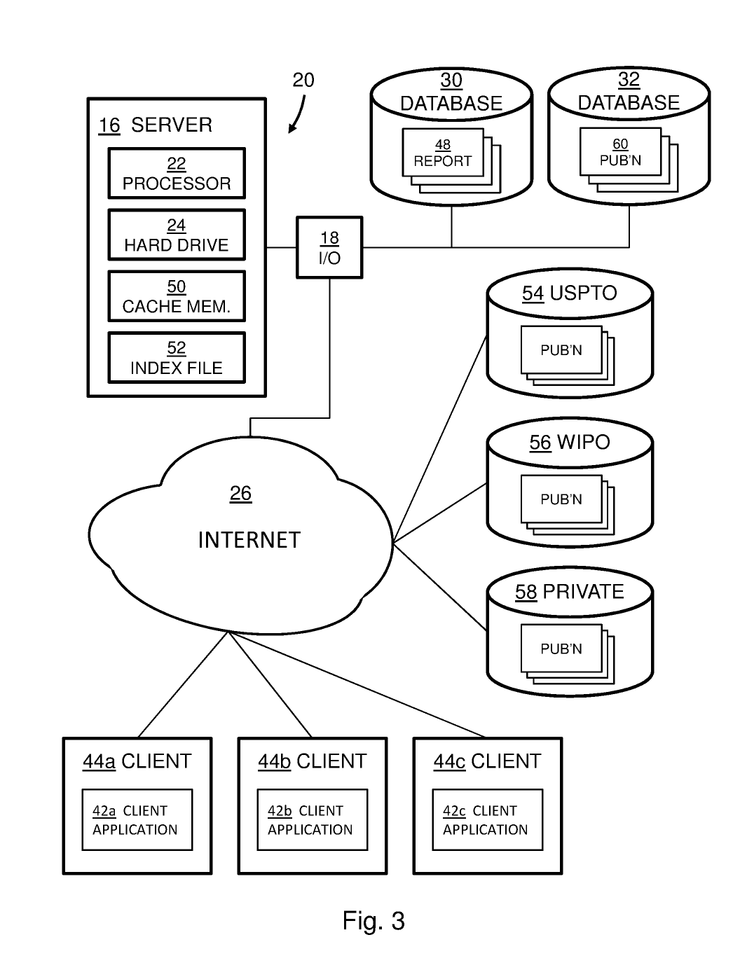

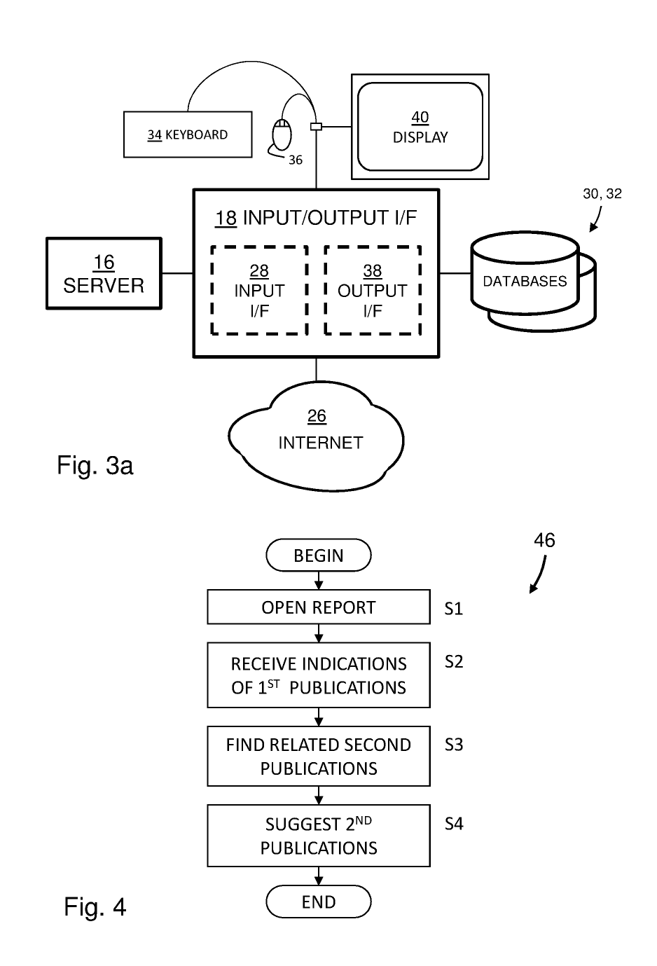

FIG. 3 presents a system including a server 16 with an input/output interface assembly 18 (the latter illustrated in the figure logically as a separate unit) embodying the invention as a reporting tool 20. The server 16 include a processor 22, such as an Intel® Core™ i5 or i7 processor, and a hard drive 24, such as a 250 GB hard drive. Example servers having such hardware include the Dell PowerEdge or the Hewlett-Packard ProLiant series. These example servers may be operated using Windows or Linux. In alternate embodiments, the functions performed by the server 16 may instead be performed by multiple servers, such as a service provided by a cloud computing solution. In this case, the servers work together under a common control with access thereto controlled by a single entity or by independent entities in the array of servers.

The input/output interface assembly 18 may be any suitable hardware that links a server to the Internet 26, including wired or wireless links to a modem as non-limiting examples. With reference to FIG. 3a, an input interface 28 is a subunit of the input/output interface assembly 18. The input interface 28 receives signals from the Internet 26, from databases 30, 32 maintained externally to the server 16 as discussed in more detail below, and from a server operator using a keyboard 34 and mouse 36 or other equivalent cursor movement device. The input interface 28 may include a USB and/or Ethernet socket(s) of the server 16. As also shown in FIG. 3a, an output interface 38 is another subunit of the input/output interface assembly 18. The output interface 38 transmits signals from the server 16 to the Internet 26, to the external databases 30, 32, and to a display 40 for the server operator to view during the course of performing his/her duties. The output interface 38 may include a VGA connector of the server 16.

A user endeavoring to generate or to edit a prior art search report uses a client application, such as a client application 42a, 42b, or 42c, residing on a client computer, such as a client 44a, 44b, or 44c, respectively, to establish communication with the reporting tool 20 through the Internet 26 and the input interface 28 as is known in the art in order to request that the reporting tool open a report. The clients 44a, 44b, 44c may be any suitable known personal computer (PC) or workstation, such as an IBM-compatible or Macintosh PC, tablet, smartphone, or the like. The reporting tool 20 assists the user in generating/editing a search report by operating according to the following method:

FIG. 4 presents a flowchart 46 representing the process flow of a method of designating publications to cite in a report according to an embodiment of the invention. The method may be executed by the reporting tool 20 of FIG. 3.

The first step of the method is to open a report in response to a request received from a client computer, such as client 44a, 44b, or 44c of FIG. 3. (Step S1.) As discussed above, a user operates a client application, such as a client application 42a, 42b, or 42c residing on a client computer, to send a request to open a report. In the system of FIGS. 3 and 3a, the server 16 receives the request from client computer 44a, 44b, or 44c via the input interface 28 of input/output interface assembly 18, and the processor 22 opens the report.

The term “open” in this context covers the scenario in which the report file referenced by the client application 42a, 42b, or 42c already exists and is stored for example in the hard drive 24 of the server 16 or in the database 30 implemented to maintain search files and corresponding reports 48. The term “open” in this context includes the retrieval of the report file from the location where it is stored.

Also for this embodiment, “open” in the context of a report file that does not pre-exist in storage before executing step S1 refers to creating a file for the report in response to the request from the client computer to open a report. The file is then saved in storage, such as in the hard drive 24, in the database 30, or in another storage device.

In some implementations of the present embodiment, the server 16 includes a cache memory 50 and/or an index file 52 to provide more efficient retrieval of search file data. Completed search reports may accumulate in the report database 30, while a report in an initial stage, perhaps embodied as little more than list of publications on a web page showing a list of publications (even a list has not yet or may never be given to another party), may be stored automatically on the cache memory before later being stored (more permanently) in the report database 30 and then erased from the cache memory 50 at the end of a report generation session.

Although only a couple types of reports are listed above, embodiments of the invention may produce other types of reports. For example, in the patent context, reports may also be generated to determine the state of the art, to determine freedom to operate, and to search for invalidating prior art (as non-limiting examples). Another example report is a periodic (such as monthly) report that lists applications assigned to a particular party (such as to a competitor) that were published during a specified time period (such as the preceding month). Still another example is a periodic report that lists newly granted patents and/or newly published application that recite a particular phrase (such as “green energy”). In an academic context, the reporting tool may be used as a research tool to find and cite relevant publications on a particular subject. In a business context, the reporting tool may be used for market research.

As discussed above, in the present embodiment the client 44a, 44b, or 44c communicates with the reporting tool 20 through the Internet 26, but in alternate embodiments a client may communicate with a reporting tool through a different network, such a local area network (LAN) perhaps maintained within an organization in which the organization's employees operate the client computers to generate and edit search reports. In still other embodiments a client application residing on a computer may interact directly with reporting tool software (discussed in more detail below) that resides on the same computer. Thus, in terms of Step S1, the opening of the report is essentially in response to a request generated within the same computer.

The next step of the present method is to receive from the client computer an indication of a publication, which will be referenced also as a “first publication” in the present disclosure. (Step S2.) In the system of FIGS. 3 and 3a, the server 16 receives the indication from the client computer 44a, 44b, or 44c via the input interface 28 of input/output interface assembly 18. A user indicates a publication that he/she wants to be listed in the search report. If the publication is an issued patent or patent application, the user may indicate the publication by sending the patent or application number from a client computer through the Internet to a server execute the presently described process, as a non-limiting example. A user may indicate an article of a technical journal by sending a unique identifier of the article, such as the Digital Object Identifier (DOI) or the uniform resource identifier (URI). Other examples of identifiers include but are not limited to an International Standard Book Number (ISBN) or an International Standard Recording Code (ISRC). The article identifies may have a formatted style, such as those of the Modern Language Association (MLA), American Psychological Association (APA), or Chicago Manual Styles so a machine will be able to index and retrieve it.

In the present embodiment, a client indicates a single publication for entry into a report, and the system suggests related publications to include in the report, as discussed below. In alternate embodiments, though, multiple publications are indicated as a first set of publications for entry into the report, and one or more publications relating to the first set of publications are suggested for the report.

In some scenarios, the user in step S1 opens a report that preexisted and already lists a publication that the user wants as the subject of the future steps. That is, the user wants the reporting tool to suggest additional publications relating to the first publication, as with the passage of time more relevant publications become available that could not have been suggested previously. Accordingly, indicating the first publication in this situation does not require the user to enter a publication name, number, or code, because he/she may simply select an entry presented in a web page provided by the reporting tool. (In an alternate scenario, the user does not even care to generate a report listing the first publication, but he/she nonetheless wants suggestions of similar prior art. The first publication is “indicated” nonetheless.)

After the reporting tool receives the indication of the publication (or set of publications), the reporting tool then uses storage to find information that links the publication (or set of publications) to one or more other publications (a “second set” of publications). (Step S3.) The storage used to find the information could be a hard drive, cache memory, and/or index file, of a server embodying the reporting tool, or one or more database that the server accesses. In the example of the server 16 of FIG. 3, the storage may be the hard drive 24, the cache memory 50, the index file 52, the report database 30, and/or the publication database 32, which stores publications 60. The invention is not limited to such storage, though. For example, the server 16 may access through the Internet 26 relevant information in databases maintained by the United States Patent and Trademark Office (PTO) (illustrated as database 54), by the World Intellectual Property Organization (WIPO) (illustrated as database 56), and/or privately maintained databases (illustrated as database 58) that may or may not require a subscription for access. The information may be formatted as one or more database records. Example ways in which publications are linked to each other include: (1) one patent listing another in its “references cited” section; and (2) a scientific publication listing another scientific publication in its bibliography. Linking may also occur if multiple reports list the same two publications, as will be discussed in more detail below.

The storage of one or more of the present embodiments may be referenced logically as a first storage and a second storage. The first storage, for example, within the hard drive 24 in FIG. 3, is connected to the processor of a reporting tool and holds instructions that activate the processor to find information that links publications. The second storage, for example, within one or more of the databases 30, 32, 54, 56, and 58, the cache memory 50, and/or the index file 52 store the linking information. The second storage may even be embodied within the hard drive 24; thus, the hard drive 24 may provide both the first and second storage.

After the reporting tool finds information that links the first publication to a second publication (or set of publications), the reporting tool sends a suggestion to the client computer to cite the publications of the second set in the report. (Step S4.) In the system of FIGS. 3 and 3a, the server 16 sends the suggestion through the output interface 38 of the input/output interface assembly 18 and then through the Internet 26 to a client application 42a, 42b, or 42c of the client computer 44a, 44b, or 44c, respectively. (The user of course ultimately decides whether he/she wants to cite a second publication.) The process of this embodiment then ends.

Steps S1-S4 of the method of the flowchart 46 may be executed by the reporting tool 20 of FIG. 3. Alternatively, the method may be executed so that a first party performs the opening the report, the receiving from the client computer, and the sending the suggestion, and an independent second party hosts the storage and performs the using the storage according to instructions from the first party. In such an arrangement, a first party may operate a server to host a reporting tool and “outsource” to or rely upon an independent party to maintain a database for the reporting tool to access.

The reporting tool may execute one or more of a multitude of processes for using the storage to find information that links publications to each other. The following describes examples of those processes. The scope of the invention is not limited to the examples presented.

Report Co-Citation

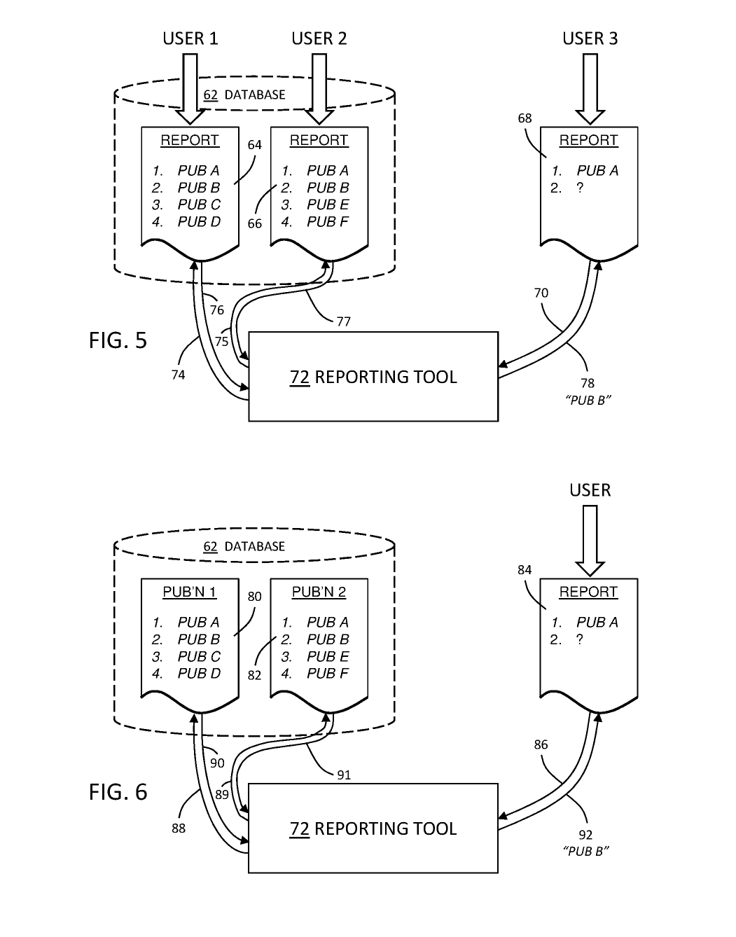

The report co-citation process for using the storage to find linking information is described with reference to FIG. 5. In this example, the storage is a database 62 holding reports that users USER 1 and USER 2 previously generated. USER 1 generated a report 64 citing publications PUB A. PUB B, PUB C, and PUB D, and USER 2 generated a report 66 citing publications PUB A. PUB B, PUB E, and PUB F. Note that, although both reports 64, 66 are stored in a single database 62, the report co-citation process is also operable when multiple storage devices are accessible and store reports.

A user USER 3 generating a report 68 has already cited publication PUB A and indicates 70 this citation to a reporting tool 72. The reporting tool 72 searches 74, 75 (or alternatively instructs 74, 75 the database 62 to search) reports stored in the database 62 that cite the publication PUB A and finds 76, 77 that the report 64 generated by USER 1 and that the report 66 generated by USER 2 both cite PUB A. The reporting tool 72 further finds 76, 77 that both reports 64, 66 cite PUB B, also. That is, the reporting tool 72 found information linking publication PUB A to publication PUB B. Accordingly, the reporting tool 72 sends 78 a suggestion to USER 3 to cite PUB B, also.

The rationale for executing the report co-citation process is that multiple prior users citing the same publication(s) (first publications) have already determined that the same additional publication(s) should be cited, also. Thus, when another user indicates to the reporting tool 72 that same first publication(s), the reporting tool 72 should suggest that the user cite also the second (additional) publication(s).

In another scenario, a user generating one or more reports that cite the same set of publications together implies that the same user generating a new report citing a publication(s) from the set would likely be interested in citing more publications from the same set. The report co-citation process can suggest citations accordingly. Also, the process can be implemented so that, for a user generating a new report, suggestions based on past reports that the user himself/herself generated and stored receive higher priority.

Variations of this process are within the scope of the invention. For example, the reporting tool 72 may suggest a second publication when it found only one prior report citing the first publication. Another example variation is that the reporting tool may require finding more than one common publication to suggest for inclusion in a report.

The steps for the report co-citation process can be encompassed by the following description: search storage (such as database 62) for at least one report that cites at least one publication a user (such as USER 3) indicates (such as publication PUB A of the report 68); find in the storage at least one report (such as report 64 and/or report 66) that cites such publication(s); find at least one publication (such as publication PUB B) cited also in the report(s) found in the storage; and suggest to the user generating a report that he/she cite the newly-found publication(s).

Publication Co-Citation

The publication co-citation process for using the storage to find linking information is described with reference to FIG. 6. In this example, the storage, the database 62, holds publications PUB′N 1 80 and PUB′N 2 82. PUB′N 1 80 cites publications PUB A, PUB B, PUB C, and PUB D, and PUB′N 2 cites publications PUB A, PUB B, PUB E, and PUB F. Although both publications PUB′N 1 80 and PUB′N 2 82 are stored in a single database 62, the publication co-citation process is also operable when multiple storage devices are accessible and store publications.

A user USER generating a report 84 has already cited publication PUB A and indicates 86 this citation to the reporting tool 72. The reporting tool 72 searches 88, 89 (or alternatively instructs 88, 89 the database 62 to search) publications stored in the database 62 that cite PUB A and finds 90, 91 that the publications PUB′N 1 80 and PUB′N 2 82 both cite PUB A. The reporting tool 72 further finds 90, 91 that both publications 80, 82 also cite PUB B. That is, the reporting tool 72 finds information linking publication PUB A to publication PUB B. Accordingly, the reporting tool 72 sends 92 a suggestion to the user to cite PUB B, also.

The rationale for executing the publication co-citation process is that a set of publications in which the respective authors thereof cited a particular publication(s) have already determined that the same additional publication(s) should be cited, also. Thus, when a user indicates to the reporting tool 72 that same first publication(s), the reporting tool 72 should suggest that the user cite also the second publication(s) (additional publications) cited with the first publication(s) in the third set of publications.

Variations of this process are within the scope of the invention. For example, the reporting tool 72 may suggest a second publication when it found in storage only one publication citing the first publication. Another example variation is that the reporting tool may find more than one common publication to suggest for inclusion in a report.

The steps for the publication co-citation process can be encompassed by the following description: search storage (such as database 62) for one more publications that cite indicated publications (such as publication PUB A); find in the storage at least one publication (such as publication PUB′N 1 and/or PUB′N 2) citing the indicated publication; find the at least one other publication (such as publication PUB B) cited also in the publications found publication; and suggest to the user generating a report that he/she cite the other publication(s) cited in the newly-found publication(s).

Report Bibliographic Coupling

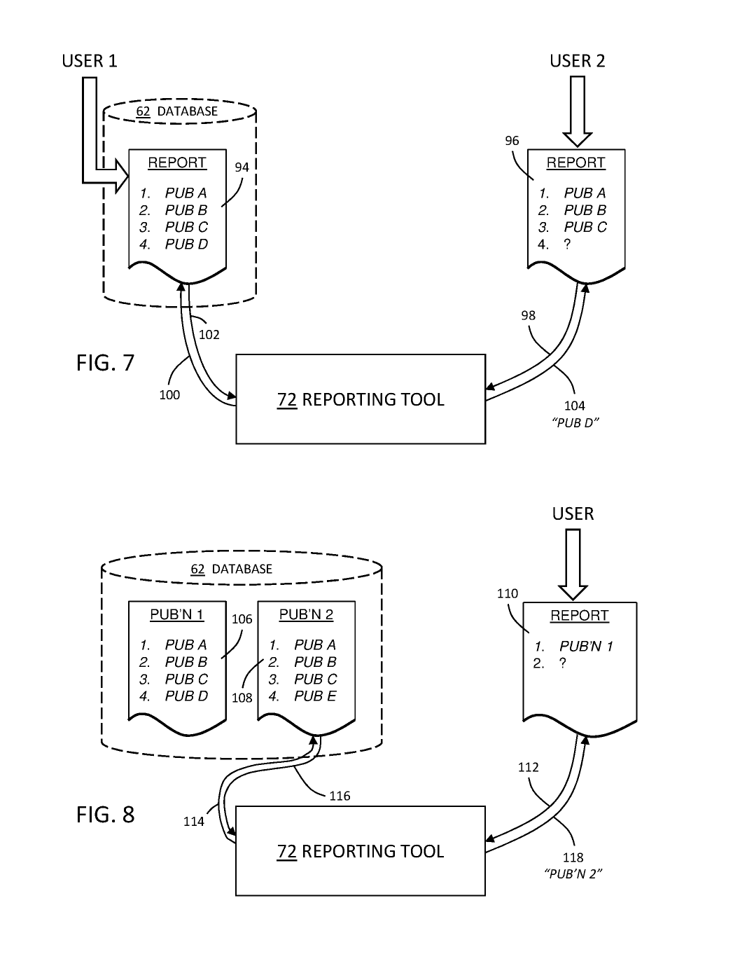

The report bibliographic coupling process for using the storage to find linking information is described with reference to FIG. 7. In this example, the storage is the database 62 holding a report 94 that user USER 1 previously generated. The report 94 cites publications PUB A. PUB B, PUB C, and PUB D.

A user USER 2 generating a report 96 has already cited publications PUB A, PUB B, and PUB C and indicates 98 these citations to the reporting tool 72. The reporting tool 72 searches 100 (or alternatively instructs 100 the database 62 to search) for reports stored in the database 62 that also cite publications PUB A, PUB B, and PUB C and finds 102 that the report 94 generated by USER 1 cites publications PUB A, PUB B, and PUB C. The reporting tool 72 further finds 102 that report 94 cites publication PUB D, also. That is, the reporting tool 72 found information linking publications PUB A, PUB B, and PUB C to publication PUB D. Accordingly, the reporting tool 72 sends 104 a suggestion to USER 2 to cite PUB D, also.

Variations of this process are within the scope of the invention. For example, the reporting tool may require finding fewer or more common publications before it suggests an additional publication for inclusion in a report.

The steps for the report bibliographic coupling process can be encompassed by the following description: search storage (such as database 62) for at least one report that cites at least one publication that a user (such as USER 2) indicates (such as publication PUB A, publication PUB B, and publication PUB C); find in the storage at least one report (such as report 94) that cites at least one of the indicated publications; find the at least one publication (such as publication PUB D) cited also in the report found in the storage; and suggest to the user generating a report that he/she cite the newly-found publication(s).

Publication Bibliographic Coupling

The publication bibliographic coupling process for using the storage to find linking information is described with reference to FIG. 8. In this example, the storage, the database 62, holds publications PUB′N 1 106 and PUB′N 2 108. PUB′N 1 106 cites publications PUB A, PUB B, PUB C, and PUB D, and PUB′N 2 108 cites publications PUB A, PUB B, PUB C, and PUB E. Although both publications PUB′N 1 106 and PUB′N 2 108 are stored in a single database 62, the publication co-citation process is also operable when multiple storage devices are accessible and store publications.

A user USER generating a report 110 has already cited publication PUB′N 1 106 and indicates 112 this citation to the reporting tool 72. The reporting tool 72 searches 114 (or alternatively instructs 114 the database 62 to search) publications stored in the database 62 for publications that cite some of the publications that the publication PUB′N 1 106 cites and finds 116 the publication PUB′N 2 108. That is, the reporting tool 72 found information linking publication PUB′N 1 106 to publication PUB′N 2 108. Accordingly, the reporting tool 72 sends 118 a suggestion to the user to cite PUB′N 2 108, also.

The rationale for executing the publication bibliographic coupling process is that citing a (first) publication (or first set of publications) that itself cites one or more publications that another (second) publication (or second set of publications) cites suggests a possibility that the second publication (or second set of publications) should be cited, also. Thus, when another user indicates to the reporting tool 72 the first publication(s), the reporting tool 72 should suggest that the user cite also the second publication(s).

The steps for the publication bibliographic coupling process can be encompassed by the following description: search storage (such as database 62) for publications that cite at least one publication (such as publication PUB A, publication PUB B, and/or publication PUB C) that an indicated publication (such as PUB′N 1) cites; and find at least one of such publications (such as PUB′N 2 108) in the storage; and suggest to the user generating a report (such as report 110) that he/she cite the newly-found publication(s).

Publication Metadata Coupling

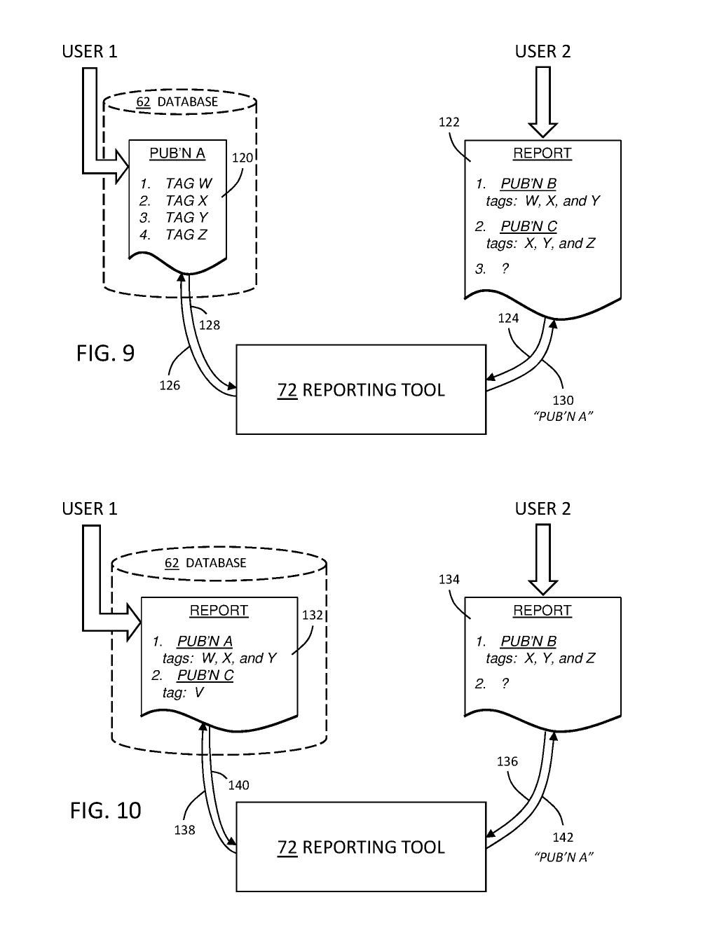

The publication metadata coupling process for using the storage to find linking information is described with reference to FIG. 9. In this example, the metadata are tags that provide descriptive information about the content of publications, such as “childhood immunizations.” Here, the storage, the database 62, holds a publication PUB′N A 120 that a user USER 1 tags with tags TAG W, TAG X, TAG Y, and TAG Z.

A user USER 2 generating a report 122 has already cited a publication PUB′N B and a publication PUB′N C and indicates 124 these citations to the reporting tool 72. Either the user USER 2 or another user had previously tagged the publication PUB′N B with tags TAG W, TAG X, and TAG Y and the publication PUB′N C with tags TAG X, TAG Y, and TAG Z. The tags may be assigned within the system of FIG. 9 or externally. In some embodiments, tags may be generated automatically. Regardless of the source, the tags of PUB′N B and PUB′N C are indicated 124 to the reporting tool 72.

The reporting tool 72 searches 126 (or alternatively instructs 126 the databases 62 to search) the database 62 for publications that are tagged with at least some of the same tags as those of the publications PUB′N B and PUB′N C cited by the user USER 2 in the report 122, and the reporting tool 72 finds 128 PUB′N A 120. That is, the reporting tool 72 finds information linking publication PUB′N A 120 to publications PUB′N B and PUB′N C. Accordingly, the reporting tool 72 sends 130 a suggestion to the user to cite PUB′N A 120, also.

The steps for the publication metadata coupling process can be encompassed by the following description: with at least one publication that a user (such as the user USER 2) indicates (such as publication PUB′N B and/or publication PUB′N C) having associated metadata (such as tags TAG W, TAG X, TAG Y, and TAG Z), search storage (such as the database 62) for at least one publication that has at least some of the same associated metadata that at least one publication of the indicated publications has; find in the storage at least one such publication (such as the publication PUB′N A); and suggest to the user generating a report (such as report 122) that he/she cite the newly-found publication(s).

Report Metadata Coupling

The report metadata coupling process for using the storage to find linking information is described with reference to FIG. 10. In this example, the metadata are tags that provide descriptive information about the content of publications. Here, the storage, the database 62, holds a report 132 that cites a publication PUB′N A that a user USER 1 tagged with tags TAG W, TAG X, and TAG Y.

A user USER 2 generating a report 134 has already cited a publication PUB′N B and then indicates 136 the citation to the reporting tool 72. The publication PUB′N B has the tags TAG X, TAG Y, and TAG Z, and these tags are also indicated 136 to the reporting tool 72. PUB′N B may have been previously tagged as indicated the user USER 2, or PUB′N B may have been tagged by the reporting tool 72 or by an external system, which may have generated or calculated the tags automatically. Perhaps a different user of the reporting tool 72 tagged the publication PUB′N B.

The reporting tool 72 searches 138 (or alternatively instructs 138 the database 62 to search) the database 62 for reports that are tagged or for reports that cite publications that are tagged with at least some of the same tags as those of the publications PUB′N B cited by the user USER 2 in the report 134, and the reporting tool 72 finds 140 the report 132 that cites the publication PUB′N A. That is, the reporting tool 72 finds information linking publication PUB′N A to publication PUB′N B. Accordingly, the reporting tool 72 sends 142 a suggestion to the user to cite PUB′N A, also. (Reports might also have associated metadata and therefore if the reporting tool 72 found a report that was tagged with at least some of the same tags as those of the user USER 2 report 134 or as those of publication PUB′N B cited by the user USER 2 in the report 134, the reporting tool 72 would send a suggestion to the user USER 2 to cite also the publications cited in that report.)

The steps for the report metadata coupling process can be encompassed by the following description: with at least one publication that a user (such as the user USER 2) indicates (such as publication PUB′N B) having associated metadata (such as tags TAG X, TAG Y, and TAG Z), search the storage (such as the database 62) for at least one report that cites at least one publication that has at least some of the same associated metadata that the publication of the first set has; and find in the storage the at least one such report (such as report 132); and suggest to the user generating a report (such as report 134) that he/she cite the newly-found publication(s).

In some implementations, even untagged or wrongly-tagged publications might also be suggested, if they were cited in a report in which other publications are tagged with the relevant tags. A publication PUB′N C in the report 132 has tag V, which is not a tag in the report 134 that the user USER 2 is generating. However, because it is in the report 132, which does have relevant tags, this implementation will suggest also the publication PUB′N C to the user USER 2 for inclusion in the report 134.

Publication Class Coupling

Documents, such as patents and technical articles, are typically grouped into classifications according to their subject matter. For example, WIPO uses the International Patent Classification (IPC) system to classify patents and utility models according to their technology. The following two processes exploit existing classification systems to generate reports.

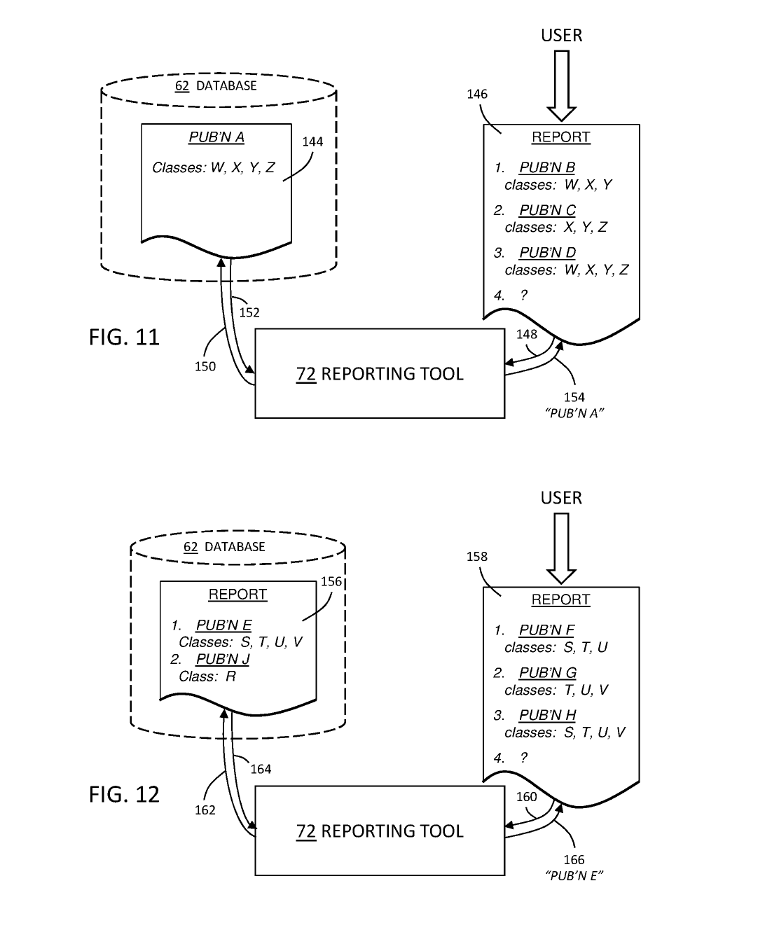

The publication class coupling process for using the storage to find linking information is described with reference to FIG. 11. In this example, the storage, the database 62, holds a publication PUB′N A 144 that has been classified in classes W, X, Y, and Z.

A user USER generating a report 146 has already cited publications PUB′N B, PUB′N C, and PUB′N D. The publication PUB′N B is classified in classes W, X, and Y, the publication PUB′N C is classified in classes X, Y, and Z, and the publication PUB′N D is classified in classes W, X, Y, and Z. The user USER indicates 148 these citations to the reporting tool 72.

The reporting tool 72 observes that three publications cited already in the report 146 are all classified in classes X and Y and further that each is classified also in class W and/or Z. The reporting tool 72 searches 150 (or alternatively instructs 150 the database 62 to search) the database 62 for publications that are also classified in both classes X and Y and also in at least one of classes W and Z. Accordingly, the reporting tool 72 finds 152 publication PUB′N A 144. That is, the reporting tool 72 finds information linking the publication PUB′N A 144 to publications PUB′N B, PUB′N C, and PUB′N D. Consequently, the reporting tool 72 sends 154 a suggestion to the user to cite PUB′N A 144, also.

Variations of the preceding example are within the scope of the invention. For example, the reporting tool 72 may use the classifications of fewer or more publications cited in the report 146 as the basis for its search in the database 62. Also, the reporting tool 72 may use fewer or more common classifications of the publications cited in the report 146 as the basis for its search in the database 62.

The steps for the publication class coupling process can be encompassed by the following description: with at least one of the publications that a user (such as the user USER in FIG. 11) indicates (such as publications PUB′N B, PUB′N C, and PUB′N D), the publication(s) being classified according to one or more classes, search storage (such as the database 62) for at least one other publication that is classified according to at least some of the same classes; find in the storage at least one such publication (such as the publication PUB′N A); and suggest to the user generating a report (such as report 144) that he/she cite the newly-found publication(s).

Report Class Coupling

The report class coupling process for using the storage to find linking information is described with reference to FIG. 12. In this example, the storage, a database 62, holds a report 156 that cites a publication PUB′N E, which has been classified in classes S, T, U, and V.

A user USER generating a report 158 has already cited publications PUB′N F, PUB′N G, and PUB′N H. The publication PUB′N F is classified in classes S, T, and U, the publication PUB′N G is classified in classes T, U, and V, and the publication PUB′N H is classified in classes S, T, U, and V. The user USER indicates 160 these citations to the reporting tool 72.

The reporting tool 72 observes that three publications cited in the report 158 are all classified in classes T and U and further that each is classified also in class S and/or V. The reporting tool 72 searches 162 (or alternatively instructs 162 the database 62 to search) the database 62 for reports that are classified or for reports that cite publications that are classified in both classes T and U and also in at least one of classes S and V. Accordingly, the reporting tool 72 finds 164 the report 156, which cites the publication PUB′N E. That is, the reporting tool 72 finds information linking the publication PUB′N E to publications PUB′N F, PUB′N G, and PUB′N H. Consequently, the reporting tool 72 sends 166 a suggestion to the user to cite the publication PUB′N E, also. (Reports might also be classified and therefore if the reporting tool 72 found a report that was classified in at least some of the same classes as those of the user USER report 158 or as those of the publications PUB′N F, PUB′N G, and PUB′N H cited by the user USER in the report 158, the reporting tool 72 would send a suggestion to the user USER to cite also the publications cited in that report.)

Variations of the preceding example are within the scope of the invention. For example, the reporting tool 72 may use the classifications of fewer or more publications cited in the report 158 as the basis for its search in the database 62. Also, the reporting tool 72 may use fewer or more common classifications of the publications cited in the report 158 as the basis for its search in the database 62.

The steps for the report class coupling process can be encompassed by the following description: with at least one publication that a user (such as the user USER in FIG. 12) indicates (such as publications PUB′N F, PUB′N G, and PUB′N H), the publication(s) being classified according to one or more classes, search storage (such as database 62) for at least one report that cites at least one publication that is classified according to at least one of the same classes; find in the storage the at least one such report (such as the report 156), the report citing such publication(s) (such as PUB′N E); and suggest to the user generating a report (such as report 158) that he/she cite the newly-found publication(s).

In some implementations, the reporting tool 72 may be configured to suggest citing publications that are unclassified or wrongly classified, if the publication was cited in a report in which other publications are classified in a fashion to be suggested. For example, the report 156 includes a publication PUB′N J that is classified in class R. Although none of the publications in the report 158 are classified in class R, an implementation may be configured to suggest the publication PUB′N J because it is in the same report as the publication PUB′N E, which has classifications in common with publications in the report 158.

Content Coupling

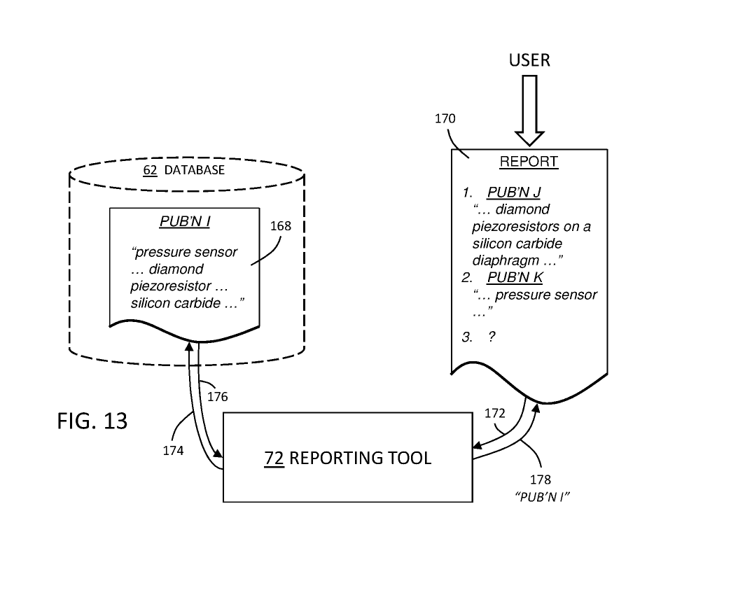

The content coupling process for using the storage to find linking information is described with reference to FIG. 13. In this example, the storage, a database 62, holds a publication PUB′N I 168 that includes the text strings “pressure sensor . . . diamond piezoresistor . . . ” and “ . . . silicon carbide . . . . ”

A user USER generating a report 170 cites a publication PUB′N J and a publication PUBN′ K. The publication PUB′N I discusses building a pressure sensor by affixing diamond piezoresistors on a silicon carbide diaphragm. Within the publication PUB′N J, a section discusses building a torque sensor by affixing diamond piezoresistors on a silicon carbide diaphragm. More specifically, the publication PUB′N J includes the phrase “ . . . diamond piezoresistors on a silicon carbide diaphragm . . . ” but does not necessarily includes the phrase “ . . . pressure sensor . . . ” The publication PUBN′ K discusses pressure sensors, but not necessarily by affixing diamond piezoresistors on a silicon carbide diaphragm. The user USER indicates 172 the citations PUB′N J and PUB′N K to the reporting tool 72.

The reporting tool 72 observes that the publication PUB′N J includes the phrase “ . . . diamond piezoresistors on a silicon carbide diaphragm . . . ” and that the publication PUB′N K includes the phrase “pressure sensor.” Accordingly, the reporting tool 72 decides to search 174 the database 62 (or alternatively instructs 174 the database 62 to search) for publications that contain the text strings “diamond piezoresistor,” “silicon carbide,” and “pressure sensor.” The reporting tool 72 finds 176 the publication PUB′N I. That is, the reporting tool 72 finds information linking the publication PUB′N I to the publications PUB′N J and PUB′N K. Consequently, the reporting tool 72 sends 178 a suggestion to the user to cite the publication PUB′N I, also.

Variations of the preceding example are within the scope of the invention. For example, the reporting tool 72 may search storage based on fewer or more text strings and/or their frequency in the publications. Also, the reporting tool 72 may use common text strings of one or more publications cited in the report 170 as the basis for its search in the database 62.

The steps for the content coupling process can be encompassed by the following description: identify one or more phrases of text (such as “ . . . diamond piezoresistors on a silicon carbide diaphragm . . . ”) from at least one publication (such as the publication PUB′N J) that a user (such as the user USER in FIG. 13) indicates; search storage (such as the database 62) for at least one other publication having at least one of the same phrases; find in the storage at least one other such publication (such as the publication PUB′N I); and suggest to the user generating a report (such as the report 170) that he/she cite the newly-found publication(s).

The preceding discussions presented algorithms that may be executed by themselves to use storage to find information that links publications in a first set to publications in a second set. In alternate embodiments, though, multiple algorithms, which each search for information that links publications of a first set to publications of a second set, may be executed. In this scenario, multiple suggestions for citing publications are sent to the client computer, and those suggestions may be prioritized according to which algorithm provided an individual suggestion.

In some embodiments of the invention, the suggested publications of the second set are presented according to one or more priority schemes. For example, with reference above to the discussion of the report co-citation and publication co-citation processes and to FIGS. 5 and 6, the existence in a database of publications and/or reports citing both publication PUB A and publication PUB B causes a reporting tool to suggest the publication PUB B if a user has already cited the publication PUB A. However, the reporting tool implementing the publication co-citation process may determine that at least one other publication PUB C should be suggested, so the suggestions are prioritized as to which publication is more likely to be of interest to the user. Examples of such prioritization are discussed as follows:

The suggestions may be prioritized according to the number of reports or publications in which a suggested publication was cited. For example, a publication cited in five different older reports stored in a database would have a higher priority than a publication cited in only two reports.

The suggestions may be prioritized according to the number of reports or publications in which a publication of the second set was cited with publications of the first set. For example, with reference to FIG. 6, in the case a user has already cited the publication PUB A and another publication PUB B was cited with the publication PUB A in two publications stored in a database, PUB B will have a higher priority than a different publication PUB C that was cited with publication PUB A in only one publication stored in a database.

The suggestions may be prioritized according to the citation originator who cited a publication of the second set in a report or in a publication and the user who cites a publication of the first set. Example citation originators are authors of past reports. For example, with reference to FIG. 5, if the user USER 1 works in the same organization with the user USER 3, who has already cited the publication PUB A, and another publication PUB C was cited with the publication PUB A by user USER 1 in past reports stored in a database, PUB C will have a higher priority than a different publication PUB E that was cited by a third user USER 2 in a report stored in a database, if USER 2 is not part of the same organization.

The suggestions may be prioritized according to the citation originator who cited a publication of the second set in a report or in a publication and the citation originator who cited a publication of the first set in the same report or publication. Example citation originators are the patent examiners who examined patents stored in a database or the applicants of the patents stored in a database. For example, with reference to FIG. 6, in the case a user has already cited the publication PUB A and another publication PUB C was cited with the publication PUB A in a publication PUB′N 1 (e.g., a patent) stored in a database in which both publications were cited by the same citation originators, e.g., an examiner of the publication PUB′N 1, the publication PUB C will have a higher priority than a different publication PUB E that was cited with publication PUB A in another publication PUB′N 2 (e.g., a patent) stored in a database in which both publications were cited by different citation originators, e.g. publication PUB A was cited by an examiner of the publication PUB′N 2 and the publication PUB E by the applicant of the publication PUB′N 2.

The suggestions may be prioritized according to the citation category in which a publication of the second set was categorized in a report or in a publication and the citation category in which a publication of the first set was categorized in the same report or publication. For example, with reference above to the discussion of the publication co-citation process and to FIG. 6 and with reference above to the discussion of document categories and to FIG. 2 showing categories X and Y, the prioritization is based on the citation category of the publication PUB SR1 and the citation category of the publication PUB SR2 as they were categorized in a patent search report of a patent stored in a database. With reference to FIG. 6, the following table provides an example prioritization ranking for the Publication PUB C when cited with Publication PUB A by an examiner of publication PUB′N 1:

| PUB A | PUB C | Rank |
|---|---|---|
| X | X | 4 |
| Y | Y | 3 |
| X | Y | 2 |
| Y | X | 2 |
| X | not X or Y | 0 |
| Y | not X or Y | 0 |
| not X or Y | X | 0 |
| not X or Y | Y | 0 |
| not X or Y | not X or Y | 0 |

Publication PUB C receives a priory rank with respect to publication PUB A. Publication PUB C is considered similar to publication PUB A if the similarity of publication PUB A to publication PUB′N 1 and the similarity of publication PUB C to publication PUB′N 1 causes a patent examiner to hold that both the publications are such that, when taken alone, a claimed invention cannot be considered novel or cannot be considered to involve an inventive step. Therefore, in the case of a user that has already cited the publication PUB A, and another publication PUB C was cited with the publication PUB A in a publication PUB′N 1 (e.g., a patent) stored in a database and both publications were cited in the same category, e.g., the X category, by an examiner of the publication PUB′N 1, publication PUB C will have a higher priority than a different publication PUB E that was cited with publication PUB A in another publication PUB′N 2 (e.g., a patent) stored in a database in which both publications were categorized in different categories, e.g. publication PUB A was categorized in X category by an examiner of the publication PUB′N 2 and publication PUB E was categorized in Y category by an examiner of the publication PUB′N 2.

The suggestions may be prioritized according to the patent claims to which a publication of the second set was indicated as relevant in a report or in a publication and to the patent claims to which a publication of the first set was indicated as relevant in the same report or publication. For example, with reference above to the discussion of the publication co-citation process and to FIG. 6 and with reference above to the discussion of document claims of relevancy and to FIG. 2 showing claims 1-3, 5, 6, 10 in the right-most column “Relevant to Claims No.,” the prioritization may be based on the patent claims to which a publication PUB SR1 was indicated as relevant and the patent claims to which a publication PUB SR2 was indicated as relevant in a patent search report of a patent stored in a database. With reference to FIG. 6, if a user has already cited the publication PUB A and another publication PUB C was cited with the publication PUB A in a publication PUB′N 1 (e.g., a patent) stored in a database and both publications were cited and indicated as relevant to similar claims, e.g., claims 1-3, by an examiner of the publication PUB′N 1, publication PUB C will have a higher priority than a different publication PUB E that was cited with publication PUB A in another publication PUB′N 2 (e.g. a patent) stored in a database in which both publications were cited and indicated as relevant to different claims, e.g., publication PUB A was indicated as relevant to claims 1-3 by an examiner of the publication PUB′N 2 and publication PUB E was indicated as relevant to claims 4-5 by an examiner of the publication PUB′N 2.

The suggestions may be prioritized according to the citation phase (for example, during patent prosecution) in which a publication of the second set was added to a report or to a publication and the citation phase in which a publication of the first set was added to the same report or publication. For example, with reference to FIG. 6, if a user has already cited the publication PUB A and another publication PUB C was cited with the publication PUB A in a publication PUB′N 1 (e.g., a patent) stored in a database and if both publications were cited during the same citation phase, e.g., the opposition phase of the publication PUB′N 1, publication PUB C will have a higher priority than a different publication PUB E that was cited with publication PUB A in another publication PUB′N 2 (e.g., a patent) stored in a database in which both publications were cited in different citation phases, e.g., publication PUB A cited in the examination phase of publication PUB′N 2 and publication PUB E cited in the opposition phase of publication PUB′N 2.

The suggestions may be prioritized according to the citation order number in which a publication of the second set was cited in a report or in a publication and the citation order number in which a publication of the first set was cited also in the same report or publication. For example, with reference to FIG. 5, in the case a user already citing the publication PUB A and another publication PUB B cited with the publication PUB A in a report stored in a database in which publication PUB A was ordered first in the report reference list and publication PUB B was ordered second in the report reference list, publication PUB B will have a higher priority than a different publication PUB C that was cited with publication PUB A and was listed third in the report reference list.

The suggestions may be prioritized according to the similarity of a citation list of a publication of the first set to a citation list of a publication of the second set. For example, if the citation list of a publication of the first set included publications A, B, and C and two publications to be suggested from the second set had citations lists such that the first list included publications A and B and the second list had only publication A, the publication having the first list would have a higher priority because its citation list is more similar to that of the publication in the first set.

The suggestions may be prioritized according to the similarity of the first set of publications to a citation list of a publication of the second set. For example, if the first set include publications A, B, and C and two publications to be suggested from the second set had citations lists such that the first list included publications A and B and the second list had only publication A, the publication having the first list would have a higher priority because its citation list is more similar to the first set.

The suggestions may be prioritized according to the metadata associated with a publication of the second set and the metadata associated publications of the first set. An example is a publication in the first set tagged with tags W, X, and Y, one publication in the second set tagged with tags W and X, and another publication in the second set tagged with tag W. The first publication in the second set would have a higher prioritization, because it has more tags in common with the publication in the first set.

The suggestions may be prioritized according to the similarity of text of the suggested publication to text of publications in the first set. Methods of comparing the text of documents are well known in the art. One example is a publication in the first set having the text “a pressure sensor having a silicon carbide diaphragm with diamond piezoresistors thereon,” one publication in the second set having the text “a pressure sensor having a silicon carbide diaphragm,” and another publication in the second set having the text “a pressure sensor.” The first publication in the second set would have a higher prioritization, because its text is more similar to that of the publication in the first set.

The suggestions may be prioritized according to the classifications in which publications of the second set are classified and the classifications in which publications of the first set are classified. An example is a publication in the first set classified in classes A, B, and C, one publication in the second set classified in classes A and B, and another publication in the second set classified in class A. The first publication in the second set would have a higher prioritization, because it has more common classifications with the publication in the first set.

The suggestions may be prioritized according to the order in which the first set is ordered. For example, if the first set include publications A listed first, B listed second, and C listed third and two publications D, E to be suggested from the second set were found with information that links the publication A of the first set to publication D of the second set and with information that links the publication B of the first set to publication E of the second set, the publication D having the links to publication A of the first set would have a higher priority than publication E, because it was found to be related to a publication that is assumed to be more important to the user who created the first set.

The invention may further be embodied as a machine readable medium holding instructions. The instructions, when executed, activate a processor to execute a method of designating publications to cite in a report. In terms of the logical designations of first and second storage (discussed above), the machine readable medium of the present embodiment provides the first storage.

As non-limiting examples, the machine readable medium could be embodied as the hard drive 24 of the server 16 of FIG. 3, the processor could be embodied the processor 22 of the server 16 of FIG. 3, and the method of designating publications to cite in a report could be the method represented by the flowchart 46 of FIG. 4. Alternatively, the a machine readable medium of the present embodiment may be an external hard drive in operative communication with a server, or the machine readable medium any of various types of non-volatile memory, such as flash memory, read-only memory (ROM), programmable read-only-memory (PROM), electronically-erasable read-only-memory (E²ROM), or equivalent non-transitory storage media. The machine readable medium may be maintained by an independent party for distribution of the instructions (embodied as software code) to others upon request.

Additional variations of the above-described embodiments are within the scope of the invention. For example, the invention does not need to be embodied as a tool on a centrally-hosted website. The invention may be embodied instead as local software installed on personal computers in communication with associated software on web-accessible servers. Alternatively, the invention may embodied as a web service to be used by a third party computer program through an application programming interface (API). The invention may also be embodied as a smartphone application that, when installed on a user's smartphone, communicates with the server. The invention may further be embodied as a software extension, for example, installed on web browsers, that communicates with the server. Further, the invention may be embodied as an embedded code snippet that a third party installs on an application, and the code snippet communicates with the server.

The invention may be embodied to work in conjunction with citation management software, docketing software, Information Disclosure Statement (IDS) generation software, and search engines.

Citation management software is software that scholars and authors use to record and utilize bibliographic citations (references). Examples of such software include EndNote® (a personal computer-based program), RefWorks (an online research management, writing, and collaboration tool), Zotero (an open source reference management software browser extension that manages bibliographic data and related research materials extension), and Aigaion (also open source reference management software that manages bibliographic data and related research materials). A publications folder may be designated to be reported and therefore the invention can be embodied to suggest additional publications to add to the folder. The suggested additional publications are related to the publications already in the folder.

Examples of docketing software include IPfolio (http://www.ipfolio.com) and ProLaw (http://www.elite.com/prolaw).

An example of IDS generation software (software that prepares IDSs) is known as “IDS Generator” (available at http://www.maxval.com/patent-tools-ids-generator.html).

Example search engines include those that have the additional functionality of enabling the marking of publications and further can export the marked publications. One such search engine is that provided by the European Patent Office (EPO). (See “My patents list” at http://worldwide.espacenet.com.) Marked publications in a designated list are the publication to be reported, and the search engine can suggest additional publications to add to the list, the suggested additional publications being related to the publications marked already.

In some embodiments of the invention, the user receives citation information, such as patent number and issue date, as suggestions of publications to include in reports, but the invention is not limited accordingly. For example, embodiments may provide additional information, such as titles, abstracts, relevant text, inventor or author names, images, and so on. Embodiments may also provide additional information, such as reasons the suggested publications are suggested, relation scores that will indicate to the user how important the suggested publication is, and so on. The information may be provided in a pre-designated format with standard fields.

In some embodiments of the invention, if the user decides to cite a publication, e.g., the suggested publication(s), the citation information, such as patent number and issue date, is included in the report.

In some other embodiments of the invention, if the user decides to cite a publication, e.g., the suggested publication(s), additional information is retrieved from the database to be included in the report. For example, embodiments may provide additional information, such as title, abstract, relevant text, inventor or author names, images, and so on. The information may be provided in a pre-designated format with standard fields.

In some embodiments of the invention, the user is able to filter the suggested publications or the publications from which they will be derived. That is, the user may specify criteria for which publications in the first set must fulfill before they may serve as the bases upon which additional citations may be suggested, and/or the user may specify criteria that publications must fulfill before they would be suggested as additional citations. Non-limiting examples of such filters for the second set are as follows:

A user specifies that he wants suggestions only from reports that were created in the last year, by certain group of users, from a certain data source, etc.

A user specifics that he wants suggestions only of publications that were published prior to a specific date, contain certain words, classifies in a specific class, etc.

Non-limiting examples of such filters for the first set include: A user specifies that he wants suggestions that are based only on, i.e., related only to, the first three (3) report publications.

A user specifies that he wants suggestions that are based only on, i.e., related only to, new publications that were added to the report at a specified time frame.

Having thus described exemplary embodiments of the invention, it will be apparent that various alterations, modifications, and improvements will readily occur to those skilled in the art. For example, the invention is not limited to the above linking algorithms. For instance, publications that may be suggested may include forward citations (newer publications which cited a publication already in a report) and backward citations (older citations that are cited by a publication already in a report). The invention is not limited to using a linking algorithm. An example of implementing the invention without a linking algorithm is storage that stores at least an index file in which publication IDs are linked or ranked with respect to one another and the reporting tool is suggesting publications based on those links. Alternations, modifications, and improvements of the disclosed invention, though not expressly described above, are nonetheless intended and implied to be within spirit and scope of the invention. Accordingly, the foregoing discussion is intended to be illustrative only; the invention is limited and defined only by the following claims and equivalents thereto.

What is claimed is:

1. A method of designating publications to cite in a report, the method comprising:
opening a report in response to a request received from a client computer;
receiving from the client computer an indication of a first set of one or more publications;
using storage to find information that links the publications of the first set to one or more publications of a second set of publications; and
sending a suggestion to the client computer to cite the publications of the second set in the report.

2. The method of claim 1, wherein the storage used includes a database.

3. The method of claim 1, wherein the storage used includes a cache memory and/or an index file.

4. The method of claim 1, wherein the opening, the receiving, the using, and the sending are implemented using a server that communicates with the client computer via a network.

5. The method of claim 1, wherein the using the storage to find information includes:
searching the storage for at least one report that cites at least one publication of the first set;
finding in the storage at least one report that cites at least one publication of the first set; and
finding the at least one publication of the second set cited also in the report found in the storage that cites at least one publication of the first set.

6. The method of claim 1, wherein the using the storage to find information includes:
searching the storage for one or more publications of a third set; the third set of publications citing publications in the first set;
finding the third set in the storage; and
finding the publications of the second set cited also in the publications of the third set.

7. The method of claim 1, wherein the using the storage to find information includes:
searching the storage for publications that cite at least one publication that the at least one publication of the first set cites; and
finding the at least one publication of the second set in the storage, the at least one publication of the second set citing at least one publication that the at least one publication of the first set cites.

8. The method of claim 1,
wherein at least one publication of the first set has associated metadata; and
wherein the using the storage to find information includes:
searching the storage for at least one publication that has at least some of the same associated metadata that the at least one publication of the first set has; and
finding in the storage at least one publication of the second set, the found publication having at least some of the same metadata associated thereto that the publication of the first set has.

9. The method of claim 1,
wherein at least one publication of the first set has associated metadata; and
wherein the using the storage to find information includes:
searching the storage for at least one report that cites at least one publication that has at least some of the same associated metadata that the publication of the first set has; and
finding in the storage the at least one report, the publication cited therein being from the second set.

10. The method of claim 1,
wherein at least one of the publications of the first set is classified according to one or more classes; and
wherein the using the storage to find information includes:
searching the storage for at least one other publication that is classified according to at least some of the same classes; and
finding in the storage at least one publication of the second set, the found publication being classified according to at least some of the same classes.

11. The method of claim 1,
wherein at least one of the publications of the first set is classified according to one or more classes; and
wherein the using the storage to find information includes:
searching the storage for at least one report that cites at least one publication that is classified according to at least one of the same classes; and
finding in the storage the at least one report, the publication cited therein being from the second set.

12. The method of claim 1, wherein the using the storage to find information includes:
identifying one or more phrases of text from at least one publication of the first set;
searching the storage for at least one other publication having at least one of the same phrases; and
finding in the storage the at least one other publication, the found publication being from the second set.

13. The method of claim 1, wherein a first party performs the opening, the receiving, the using, and the sending, and an independent second party hosts the storage.

14. The method of claim 1, wherein a first party performs the opening the report, the receiving from the client computer, and the sending the suggestion, and an independent second party hosts the storage and performs the using the storage according to instructions from the first party.

15. The method of claim 1,
wherein the using of the storage to find information that links the publications of the first set to publications of the second set includes executing multiple algorithms that each search for the information, and
wherein multiple suggestions for citing publications are sent to the client computer, the suggestions being prioritized according to which algorithm provided an individual suggestion.

16. The method of claim 1, wherein the suggested publications of the second set are prioritized according to at least one of:
the number of reports or publications in which a publication of the second set was cited;
the number of reports or publications in which a publication of the second set was cited with publications of the first set;
the citation originator who cited a publication of the second set in a report or in a publication and the user who cites a publication of the first set;
the citation originator who cited a publication of the second set in a report or in a publication and the citation originator who cited a publication of the first set in the same report or publication;
the citation category in which a publication of the second set was categorized in a report or in a publication and the citation category in which a publication of the first set was categorized in the same report or publication;
the patent claims to which a publication of the second set was indicated as relevant in a report or in a publication and the patent claims to which a publication of the first set was indicated as relevant in the same report or publication;
the citation phase in which a publication of the second set was added to a report or to a publication and the citation phase in which a publication of the first set was added to the same report or publication;
the citation order number in which a publication of the second set was cited in a report or in a publication and the citation order number in which a publication of the first set was cited also in the same report or publication;
the similarity of a citation list of a publication of the second set to a citation list of a publication of the first set;
the similarity of the first set of publications to a citation list of a publication of the second set;
the metadata associated with a publication of the second set and metadata associated publications of the first set;
the similarity of text of a publication of the second set to text of publications of the first set;
the classifications of publications of the second and the classifications of publications of the first set; and
the order in which publications in the first set are listed.

17. A reporting tool comprising:
an input interface operative to receive from a client computer (1) a request to open a report and (2) an indication of a first set of one or more publications;
a processor operative to open the report in response to the request;
a first storage operatively connected to the processor and holding instructions that when executed activate the processor to use a second storage to find information that links at least one publication in the first set to one or more publications of a second set of one or more publications; and
an output interface operative to send to the client computer a suggestion to cite the publications of the second set in the report.

18. The reporting tool of claim 17, wherein the second storage includes a database.

19. The reporting tool of claim 17, wherein the second storage includes a cache memory and/or an index file.

20. The reporting tool of claim 17, wherein the input interface and the output interface communicate with the client computer via a network.

21. The reporting tool of claim 17, wherein the processor when activated uses the second storage to find information by:
searching the second storage for at least one report that cites at least one publication of the first set;
finding in the second storage at least one report that cites at least one publication of the first set; and
finding the at least one publication of the second set cited also in the report found in the second storage that cites at least one publication of the first set.

22. The reporting tool of claim 17, wherein the processor when activated uses the second storage to find information by:
searching the second storage for one more publications of a third set; the third set of publications citing publications in the first set;
finding the third set in the second storage; and
finding the publications of the second set cited also in the publications of the third set.

23. The reporting tool of claim 17, wherein the processor when activated uses the second storage to find information by:
searching the second storage for publications that cite at least one publication that the at least one publication of the first set cites; and
finding the at least one publication of the second set in the second storage, the at least one publication of the second set citing at least one publication that the at least one publication of the first set cites.

24. The reporting tool of claim 17,
wherein at least one publication of the first set has associated metadata; and
wherein the processor when activated uses the second storage to find information by:
searching the second storage for at least one publication that has at least some of the same associated metadata that the at least one publication of the first set has; and
finding in the second storage at least one publication of the second set, the found publication having at least some of the same metadata associated thereto that the publication of the first set has.

25. The reporting tool of claim 17,
wherein at least one publication of the first set has associated metadata; and
wherein the processor when activated uses the second storage to find information by:
searching the second storage for at least one report that cites at least one publication that has at least some of the same associated metadata that the publication of the first set has; and
finding in the second storage the at least one report, the publication cited therein being from the second set.

26. The reporting tool of claim 17,
wherein at least one of the publications of the first set is classified according to one or more classes; and
wherein the processor when activated uses the second storage to find information by:
searching the second storage for at least one other publication that is classified according to at least some of the same classes; and
finding in the second storage at least one publication of the second set, the found publication being classified according to at least some of the same classes.

27. The reporting tool of claim 17,
wherein at least one of the publications of the first set is classified according to one or more classes; and
wherein the processor when activated uses the second storage to find information by:
searching the second storage for at least one report that cites at least one publication that is classified according to at least one of the same classes; and
finding in the second storage the at least one report, the publication cited therein being from the second set.

28. The reporting tool of claim 17, wherein the processor when activated uses the second storage to find information by:
identifying one or more phrases of text from at least one publication of the first set;
searching the second storage for at least one other publication having at least one of the same phrases; and
finding in the second storage the at least one other publication, the found publication being from the second set.

29. The reporting tool of claim 17 further comprising:
the second storage.

30. The reporting tool of claim 17, wherein the second storage that the processor uses is maintained by a party independent of the party maintaining the reporting tool.

31. The reporting tool of claim 17, wherein the second storage that the processor uses is maintained according to instructions from the party maintaining the reporting tool.

32. The reporting tool of claim 17,
wherein the processor when activated uses the second storage to find information that links the publications of the first set to publications of the second set by executing multiple algorithms that each search for the information, and
wherein multiple suggestions for citing publications are sent to the client computer, the suggestions being prioritized according to which algorithm provided an individual suggestion.

33. The reporting tool of claim 17, wherein the suggested publications of the second set are prioritized according to at least one of:
the number of reports or publications in which a publication of the second set was cited;
the number of reports or publications in which a publication of the second set was cited with publications of the first set;
the citation originator who cited a publication of the second set in a report or in a publication and the user who cites a publication of the first set;
the citation originator who cited a publication of the second set in a report or in a publication and the citation originator who cited a publication of the first set in the same report or publication;
the citation category in which a publication of the second set was categorized in a report or in a publication and the citation category in which a publication of the first set was categorized in the same report or publication;
the patent claims to which a publication of the second set was indicated as relevant in a report or in a publication and the patent claims to which a publication of the first set was indicated as relevant in the same report or publication;
the citation phase in which a publication of the second set was added to a report or to a publication and the citation phase in which a publication of the first set was added to the same report or publication;
the citation order number in which a publication of the second set was cited in a report or in a publication and the citation order number in which a publication of the first set was cited also in the same report or publication;
the similarity of a citation list of a publication of the second set to a citation list of a publication of the first set;
the similarity of the first set of publications to a citation list of a publication of the second set;
the metadata associated with a publication of the second set and metadata associated publications of the first set;
the similarity of text of a publication of the second set to text of publications of the first set;
the classifications of publications of the second and the classifications of publications of the first set; and
the order in which publications in the first set are listed.

34. A machine readable medium holding instructions that when executed activate a processor to execute a method of designating publications to cite in a report, the method comprising:
opening a report in response to a request received from a client computer;
receiving from the client computer an indication of a first set of one or more publications;
using storage to find information that links the publications of the first set to one or more publications of a second set of publications; and
sending a suggestion to the client computer to cite the publications of the second set in the report.

35. The medium of claim 34, wherein the storage used includes a database.

36. The medium of claim 34, wherein the storage used includes a cache memory and/or an index file.

37. The medium of claim 34, wherein the opening, the receiving, the using, and the sending are implemented using a server that communicates with the client computer via a network.

38. The medium of claim 34, wherein the using the storage to find information includes:
searching the storage for at least one report that cites at least one publication of the first set;
finding in the storage at least one report that cites at least one publication of the first set; and
finding the at least one publication of the second set cited also in the report found in the storage that cites at least one publication of the first set.

39. The medium of claim 34, wherein the using the storage to find information includes:
searching the storage for one more publications of a third set; the third set of publications citing publications in the first set;
finding the third set in the storage; and
finding the publications of the second set cited also in the publications of the third set.

40. The medium of claim 34, wherein the using the storage to find information includes:
searching the storage for publications that cite at least one publication that the at least one publication of the first set cites; and
finding the at least one publication of the second set in the storage, the at least one publication of the second set citing at least one publication that the at least one publication of the first set cites.

41. The medium of claim 34,
wherein at least one publication of the first set has associated metadata; and
wherein the using the storage to find information includes:
searching the storage for at least one publication that has at least some of the same associated metadata that the at least one publication of the first set has; and
finding in the storage at least one publication of the second set, the found publication having at least some of the same metadata associated thereto that the publication of the first set has.

42. The medium of claim 34,
wherein at least one publication of the first set has associated metadata; and
wherein the using the storage to find information includes:
searching the storage for at least one report that cites at least one publication that has at least some of the same associated metadata that the publication of the first set has; and
finding in the storage the at least one report, the publication cited therein being from the second set.

43. The medium of claim 34,
wherein at least one of the publications of the first set is classified according to one or more classes; and
wherein the using the storage to find information includes:
searching the storage for at least one other publication that is classified according to at least some of the same classes; and
finding in the storage at least one publication of the second set, the found publication being classified according to at least some of the same classes.

44. The medium of claim 34,
wherein at least one of the publications of the first set is classified according to one or more classes; and
wherein the using the storage to find information includes:
searching the storage for at least one report that cites at least one publication that is classified according to at least one of the same classes; and
finding in the storage the at least one report, the publication cited therein being from the second set.

45. The medium of claim 34, wherein the using the storage to find information includes:
identifying one or more phrases of text from at least one publication of the first set;
searching the storage for at least one other publication having at least one of the same phrases; and
finding in the storage the at least one other publication, the found publication being from the second set.

46. The medium of claim 34, wherein a first party performs the opening, the receiving, the using, and the sending, and an independent second party hosts the storage.

47. The medium of claim 34, wherein a first party performs the opening the report, the receiving from the client computer, and the sending the suggestion, and an independent second party hosts the storage and performs the using the storage according to instructions from the first party.

48. The medium of claim 34,
wherein the using of the storage to find information that links the publications of the first set to publications of the second set includes executing multiple algorithms that each search for the information, and
wherein multiple suggestions for citing publications are sent to the client computer, the suggestions being prioritized according to which algorithm provided an individual suggestion.

49. The medium of claim 34, wherein the suggested publications of the second set are prioritized according to at least one of:
the number of reports or publications in which a publication of the second set was cited;
the number of reports or publications in which a publication of the second set was cited with publications of the first set;
the citation originator who cited a publication of the second set in a report or in a publication and the user who cites a publication of the first set;
the citation originator who cited a publication of the second set in a report or in a publication and the citation originator who cited a publication of the first set in the same report or publication;
the citation category in which a publication of the second set was categorized in a report or in a publication and the citation category in which a publication of the first set was categorized in the same report or publication;
the patent claims to which a publication of the second set was indicated as relevant in a report or in a publication and the patent claims to which a publication of the first set was indicated as relevant in the same report or publication;
the citation phase in which a publication of the second set was added to a report or to a publication and the citation phase in which a publication of the first set was added to the same report or publication;
the citation order number in which a publication of the second set was cited in a report or in a publication and the citation order number in which a publication of the first set was cited also in the same report or publication;
the similarity of a citation list of a publication of the second set to a citation list of a publication of the first set;
the similarity of the first set of publications to a citation list of a publication of the second set;
the metadata associated with a publication of the second set and metadata associated publications of the first set;
the similarity of text of a publication of the second set to text of publications of the first set;
the classifications of publications of the second and the classifications of publications of the first set; and
the order in which publications in the first set are listed.
